(19) United States
(12) Patent Application Publication
(10) Pub. No.: US 2025/0355968 A1
(43) Pub. Date: Nov. 20, 2025

(54) INFORMATION PROCESSING DEVICE AND METHOD

(71) Applicants: SONY SEMICONDUCTOR SOLUTIONS CORPORATION, KANAGAWA (JP); SONY GROUP CORPORATION, TOKYO (JP)

(72) Inventors: TAKUYA KITAMURA, KANAGAWA (JP); HIRONARI SAKURAI, TOKYO (JP)

(21) Appl. No.: 18/871,398

(22) PCT Filed: May 22, 2023
(86) PCT No.: PCT/JP2023/018871

§ 371 Date: Dec. 3, 2024

(30) Foreign Application Priority Data
Jun. 10, 2022 (JP) 2022-094174

(51) Int. Cl. G06F 18/213

(52) U.S. Cl. CPC G06F 18/213

(57) ABSTRACT

The present disclosure relates to an information processing device and method that can suppress an increase in data size of a feature map. A difference between a feature map that is a processing result of a computational layer subject to processing of a neural network and an asymptotic value of an activation function of the computational layer subject to processing is derived, and the difference is encoded by a quantization-based method where a midpoint of a quantization step size is not set as a quantization level for zero input. Furthermore, the encoded data is decoded to generate the difference between the feature map and the asymptotic value, and the feature map is derived using the difference and the asymptotic value. The present disclosure is applicable to, for example, an information processing device, an image processing device, an electronic device, an information processing method, an image processing method, a program, or the like.

### TECHNICAL FIELD

The present disclosure relates to an information processing device and method, and more particularly, to an information processing device and method that can suppress an increase in data size of a feature map.

### BACKGROUND ART

In the related art, a deep neural network (DNN) is available as a useful recognition technology (see, for example, Non-Patent Document 1). With the DNN, multi-layered computational processing with over 100 layers or more is executed to obtain a recognition result. A computational result of each layer is also referred to as feature map.

As a method for implementing such a DNN, proposed is a method where processing is executed for each computational layer; to be specific, after processing of a certain layer is executed, a feature map, which is a computational result, is temporarily stored in a memory, and then processing of the next layer is executed using the data, rather than implementing all the layers with a parallel operation pipeline.

The size of the feature map, however, varies in a manner that depends on the computational layer, and there is a possibility that the data size is larger than the input of the DNN. Therefore, in the method where computation is executed on a computational layer-by-computational layer basis, there is a possibility that the memory capacity required for storing the feature map increases because it is required that an area larger than or equal to the maximum feature map be allocated.

Incidentally, a method where a feature map is spatially divided and then processed, and results of the processing are combined has been proposed (see, for example, Non-Patent Document 2). It is possible to suppress, by dividing data and staggering the timing of memory storage, an increase in the memory capacity required for storing the feature map.

### CITATION LIST

### Non-Patent Document

Non-Patent Document 1: dprogrammer, “Convolutional Neural Network (CNN) Convolutional neural network introduction and tutorial”, http://dprogrammer.org/convolutional-neural-network-cnn. Jan. 22, 2019

### Patent Document

Patent Document 1: U.S. Patent Application Publication No. 2020/0090030

### SUMMARY OF THE INVENTION

### Problems to be Solved by the Invention

Such a method, however, requires an overlapping portion (overlap) in order to create data necessary for computation. Therefore, there is a possibility that the computational load increases as compared with a case where the area is not divided. Furthermore, since the data of each area obtained as a result of division is not simultaneously stored in the memory, the method suffers not only an increase in processing time, but also an increase in complexity of managing data and processing as compared with a case where the area is not divided, so that the method is determined not to be practical.

The present disclosure has been made in view of such circumstances, and it is therefore an object of the present disclosure to suppress an increase in data size of a feature map.

### Solutions to Problems

An information processing device according to one aspect of the present technology is an information processing device including: a computational unit that derives a difference between a feature map that is a processing result of a computational layer subject to processing of a neural network and an asymptotic value of an activation function of the computational layer subject to processing; and an encoder that encodes the difference by a quantization-based method where a midpoint of a quantization step size is not set as a quantization level for zero input.

An information processing method according to one aspect of the present technology is an information processing method including: deriving a difference between a feature map that is a processing result of a computational layer subject to processing of a neural network and an asymptotic value of an activation function of the computational layer subject to processing; and encoding the difference by a quantization-based method where a midpoint of a quantization step size is not set as a quantization level for zero input.

An information processing device according to another aspect of the present technology is an information processing device including: a decoder that decodes encoded data to generate a difference between a feature map that is a processing result of a computational layer subject to processing of a neural network and an asymptotic value of an activation function of the computational layer subject to processing; and a first computational unit that derives the feature map using the difference and the asymptotic value.

An information processing method according to another aspect of the present technology is an information processing method including: decoding encoded data to generate a difference between a feature map that is a processing result of a computational layer subject to processing of a neural network and an asymptotic value of an activation function of the computational layer subject to processing; and deriving the feature map using the difference and the asymptotic value.

In the information processing device and method according to one aspect of the present technology, a difference between a feature map that is a processing result of a computational layer subject to processing of a neural network and an asymptotic value of an activation function of the computational layer subject to processing is derived, and the difference is encoded by a quantization-based method where a midpoint of a quantization step size is not set as a quantization level for zero input.

In the information processing device and method according to another aspect of the present technology, encoded data is decoded to generate a difference between a feature map that is a processing result of a computational layer subject to processing of a neural network and an asymptotic value of an activation function of the computational layer subject to processing, and the feature map is derived using the difference and the asymptotic value.

### BRIEF DESCRIPTION OF DRAWINGS

FIG. 1 is a diagram illustrating a configuration example of a neural network.

FIG. 2 is a diagram illustrating an example of how processing is executed by a DNN parser.

FIG. 3 is a diagram illustrating an example of a parameter.

FIG. 4 is a diagram illustrating an example of a computational layer.

FIG. 5 is a diagram illustrating an example of how a convolution operation is executed.

FIG. 6 is a diagram illustrating an example of an activation function.

FIG. 7 is a diagram illustrating an example of a computational layer.

FIG. 8 is a flowchart illustrating an example of a flow of DNN processing.

FIG. 9 is a diagram illustrating an example of how to suppress an increase in data size of a feature map.

FIG. 10 is a block diagram illustrating an example of a primary configuration of a DNN processing device.

FIG. 11 is a diagram illustrating an example of how processing is executed by a DNN parser.

FIG. 12 is a diagram illustrating an example of a computational layer.

FIG. 13 is a diagram illustrating an example of an activation function.

FIG. 14 is a diagram illustrating an example of quantization.

FIG. 15 is a flowchart illustrating an example of a flow of DNN processing.

FIG. 16 is a flowchart illustrating an example of a flow of data write processing.

FIG. 17 is a flowchart illustrating an example of a flow of data read processing.

FIG. 18 is a diagram illustrating an example of quantization.

FIG. 19 is a diagram illustrating an example of an activation function.

FIG. 20 is a diagram illustrating an example of a computational layer.

FIG. 21 is a diagram illustrating an example of inter-chip transmission.

FIG. 22 is a block diagram illustrating an example of a primary configuration of a computer.

### MODE FOR CARRYING OUT THE INVENTION

Hereinafter, modes for carrying out the present disclosure (hereinafter referred to as embodiments) will be described. Note that the description will be given in the following order.
1. Output of feature map with DNN
2. Encoding and decoding of feature map
3. Application Example
4. Appendix

### 1. Output of Feature Map With DNN

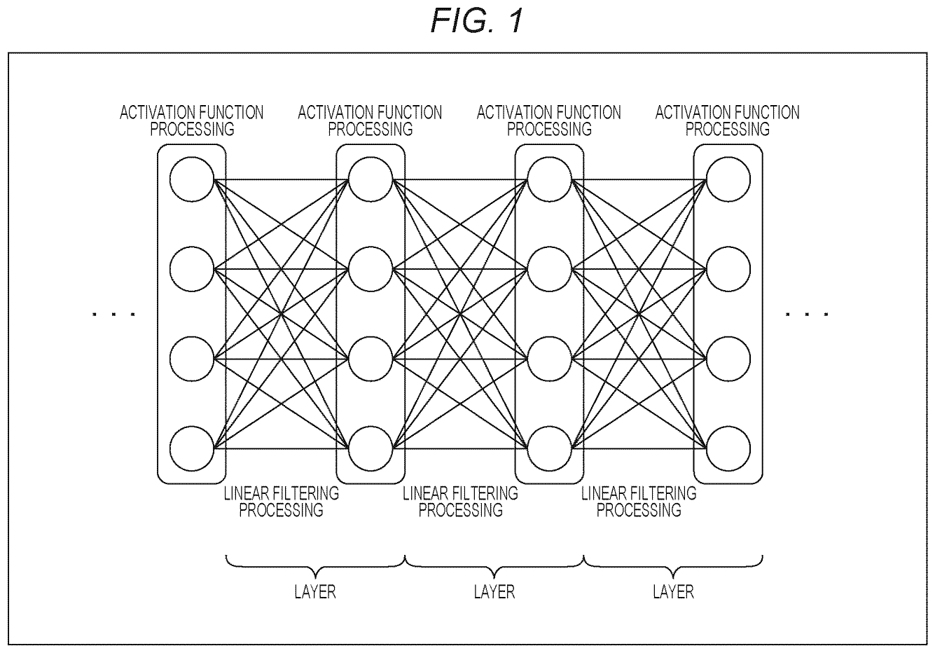

In the related art, a deep neural network (DNN) as described in Non-Patent Document 1 is available as a useful recognition technology. With the DNN, for example, as illustrated in FIG. 1, a plurality of computational layers including linear filtering processing and activation function processing is formed, and computational processing of each computational layer is executed between input and output. Multi-layered computational processing with over 100 layers or more is executed to obtain a recognition result. A computational result of each layer is also referred to as feature map.

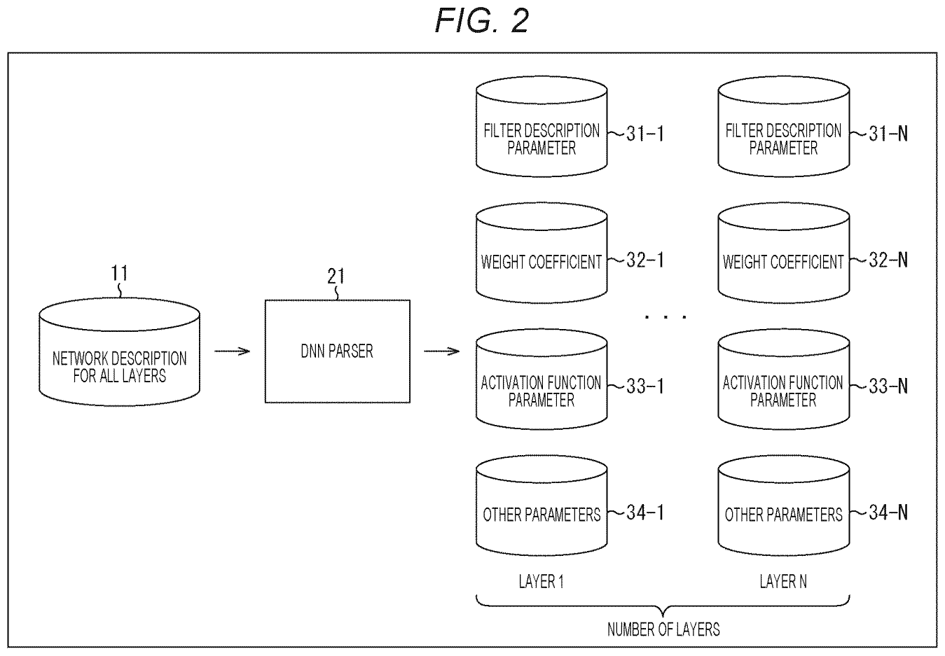

As illustrated in FIG. 2, the specification of each layer of the DNN is determined by a DNN parser 21 parsing a network description 11 for all the layers. For example, the DNN parser 21 parses the network description 11 for all the layers to generate a filter description parameter 31-1, a weight coefficient (Weight) 32-1, an activation function parameter 33-1, and other parameters 34-1 for a layer 1. The DNN parser 21 executes similar processing on each layer of the layer 1 to a layer N to generate such pieces of data. It is possible to construct the DNN by applying each piece of data generated as described above to the corresponding layer. For example, a .tflite format or the like is used for the network description for all the layers.

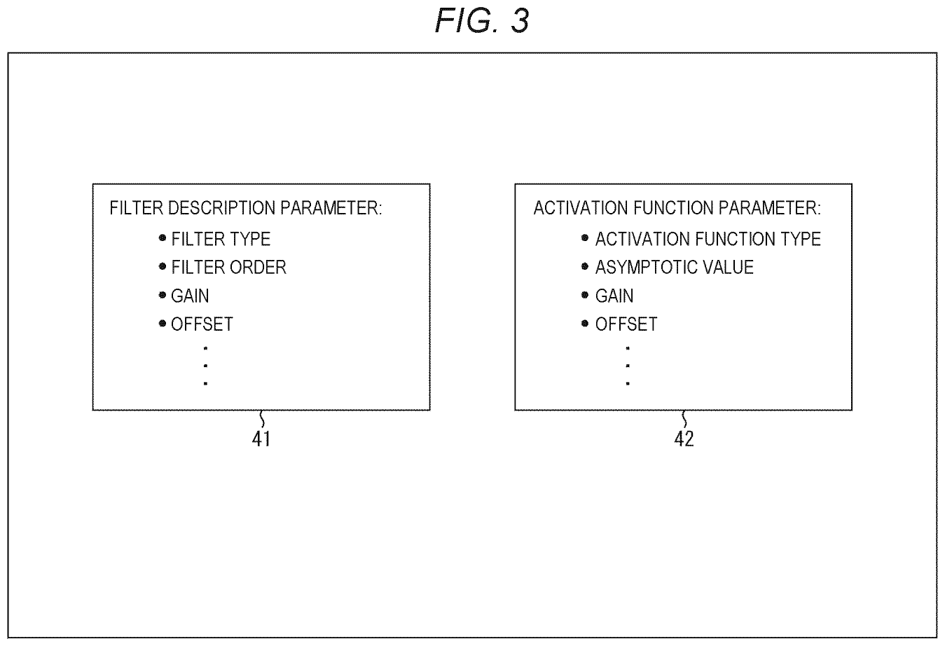

The filter description parameter may include information such as a filter type, a filter order, a gain, and an offset as shown within a rectangle 41 in FIG. 3, for example. The activation function parameter may include information such as an activation function type, an asymptotic value, a gain, and an offset as shown within a rectangle 42 in FIG. 3, for example.

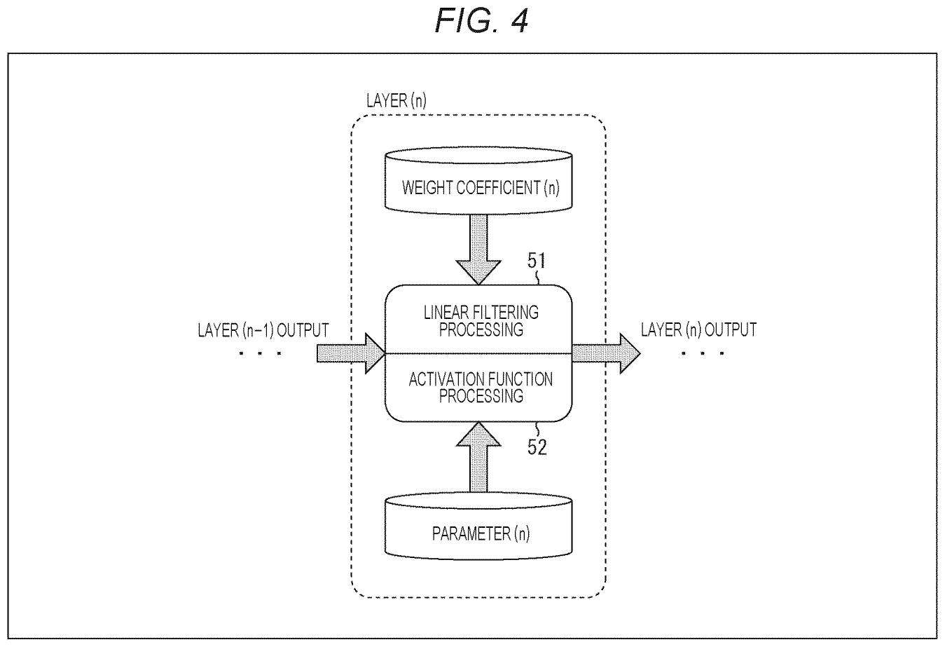

As illustrated in FIG. 4, each layer of the DNN includes linear filtering processing 51 and activation function processing 52. The linear filtering processing 51 is processing of applying convolution, multiply-accumulation, or the like to the feature map output from the previous layer using a weight coefficient.

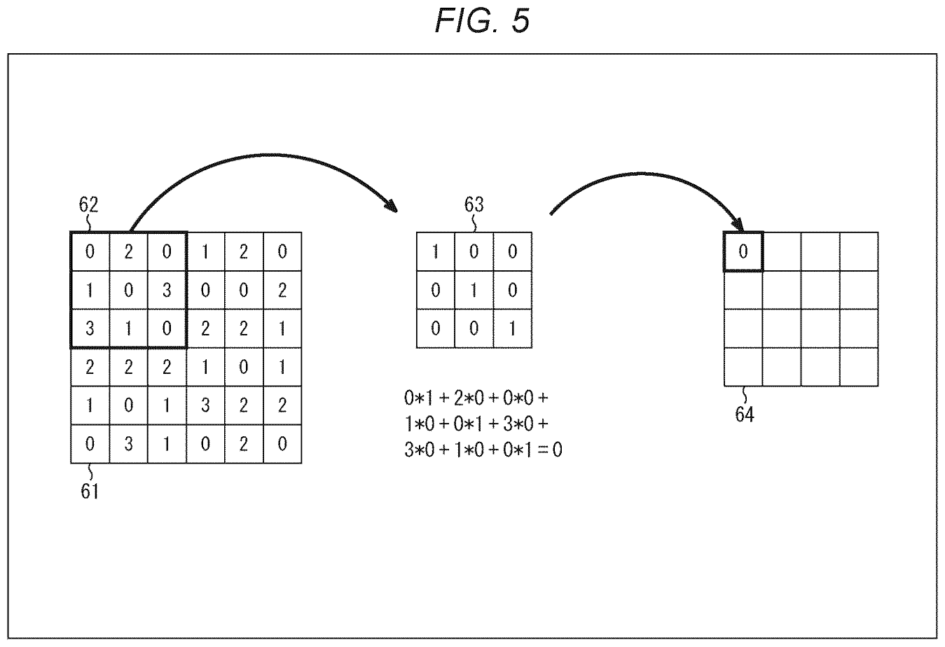

In the linear filtering processing 51, for example, a convolution operation using a convolution filter is executed. For example, image data 61 in FIG. 5 is set as data subject to processing. In the image data 61, each square indicates a pixel, the number of rows of the squares indicates a vertical width of the image, the number of columns indicates a horizontal width, and a numerical value in each square indicates a pixel value. In the case of an image, in general, the pixel value of a certain pixel has some relationship with the pixel values of its surrounding pixels. Therefore, for the convolution operation on such image data 61, a matrix is used as a filter.

For example, a filter 63 (3×3 in this case) is applied to a predetermined range (3×3 pixels in this case) indicated by a bold frame 62. That is, a matrix operation is executed using each pixel value in the bold frame 62 and each coefficient of the filter 63 to derive one value (filtering processing result 64). As a result of repeating such a matrix operation while shifting the position of the bold frame 62 one pixel at a time, a 4×4 filtering processing result 64 is obtained. Such an operation is referred to as convolution operation.

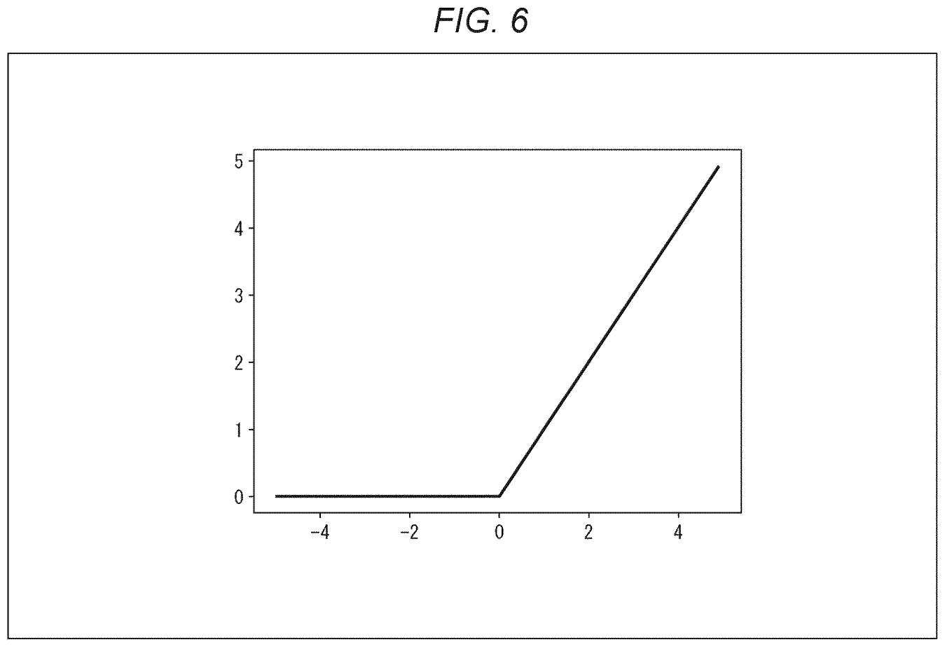

The activation function processing 52 is processing of generating a feature map by non-linearly mapping the results of the linear filtering processing 51 on the same layer. The feature map generated by the activation function processing 52 corresponds to output of this layer. The non-linear mapping is executed using an activation function. For example, a ramp function (also referred to as rectified linear unit (ReLU) function) as illustrated in FIG. 6 may be applied to the activation function. The type and characteristics of the activation function are defined by parameters unique to each layer. The results from the DNN parser are applied to such parameters.

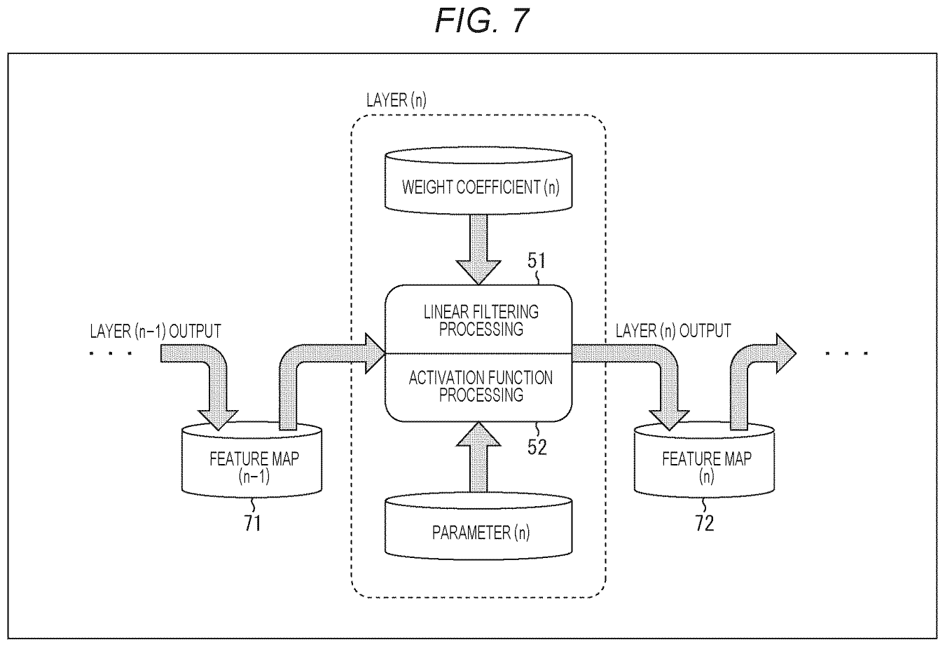

As a method for implementing such a DNN, proposed is a method where processing is executed for each computational layer; specifically speaking, as illustrated in FIG. 7, after processing of a certain layer is executed, a feature map, which is a computational result, is temporarily stored in a memory (such a memory 71 or a memory 72 in FIG. 7), and then processing of the next layer is executed using the data, rather than implementing all the layers with a parallel operation pipeline.

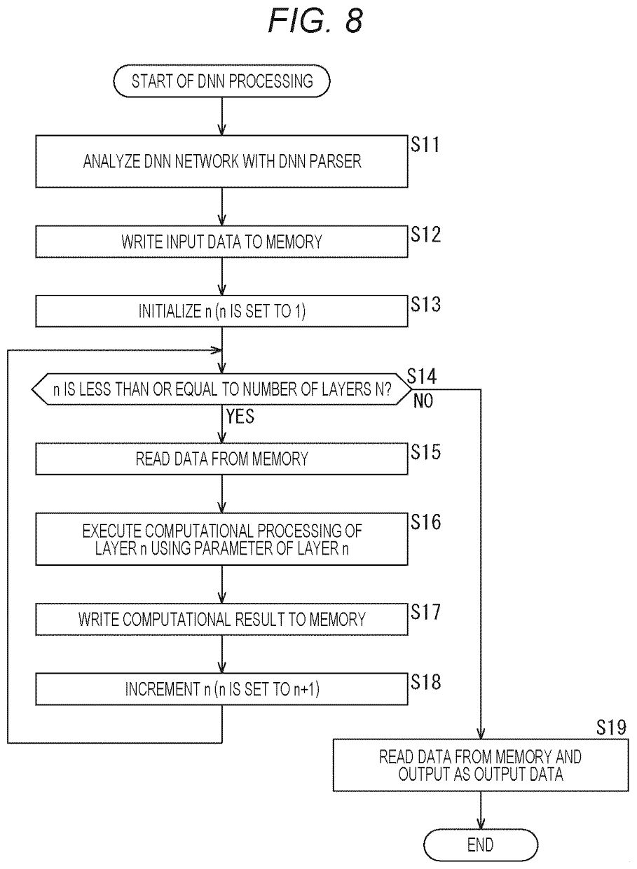

FIG. 8 illustrates an example of a flow of processing (DNN processing) in that case. First, the network description for all the layers of the DNN is parsed by the DNN parser (step S11). Then, input data is written to the memory (step S12), and a parameter n is initialized (the parameter n is set to “1”) (step S13).

Next, a determination is made as to whether or not the value of the parameter n is less than or equal to the number of computational layers N of the DNN (step S14). In a case where the value of the parameter n is determined to be less than or equal to N, data is read from the memory (step S15). If n=1, input data is read. If n>1, the computational result (feature map) of the previous layer is read.

Then, computational processing (linear filtering processing and activation function processing) of the layer n is executed on the read data using the parameters of the layer n obtained as a result of the processing (parsing the network description) in step S11 (step S16).

When the computational result (feature map) of the layer n is obtained, the computational result is written to the memory (step S17). Then, the parameter n is incremented (“1” is added to the value of the parameter n) (step S18). Then, the processing returns to step S14, and the subsequent processing is repeated. That is, the processing of steps S14 to S18 is executed on each computational layer.

Then, in a case where the value of the parameter n is determined to be greater than the number of computational layers N of the DNN in step S14, that is, in a case where the processing of steps S14 to S18 has been executed for all the layers, data (feature map) is read from the memory and output the data as output data of the DNN (step S19).

Note that since the feature map is generally large in data size, if the feature maps of all the layers are stored, the memory capacity required for storing the feature maps increases, and there is a possibility that cost and the like increase. Therefore, a method where, without holding the feature maps of all the layers, a used feature map area is released, and an area is allocated on an as-needed basis has been proposed. For example, in the DNN processing in FIG. 8, after the data is read from the memory in step S15, the read data is deleted from the memory. It is therefore possible to write the computational result to the same memory area in step S17. With such a configuration, it is possible to reduce the memory capacity required for storing the feature map.

The size of the feature map, however, varies in a manner that depends on the computational layer, and may be larger than the input of the DNN. Therefore, in the method where computation is executed on a computational layer-by-computational layer basis, there is a possibility that the memory capacity required for storing the feature map increases because it is required that an area larger than or equal to the maximum feature map be allocated.

Non-Patent Document 2 discloses a method where the feature map is spatially divided and then processed, and the results of the processing are combined. It is possible to suppress, by dividing data and staggering the timing of memory storage, an increase in the memory capacity required for storing the feature map. Such a method, however, requires an overlapping portion (overlap) in order to create data necessary for computation. Therefore, there is a possibility that the computational load increases as compared with a case where the area is not divided. Furthermore, since the data of each area obtained as a result of division is not simultaneously stored in the memory, the method suffers not only an increase in processing time, but also an increase in complexity of managing data and processing as compared with a case where the area is not divided, so that the method is determined not to be practical.

### 2. Encoding and Decoding of Feature Map

### <Method 1>

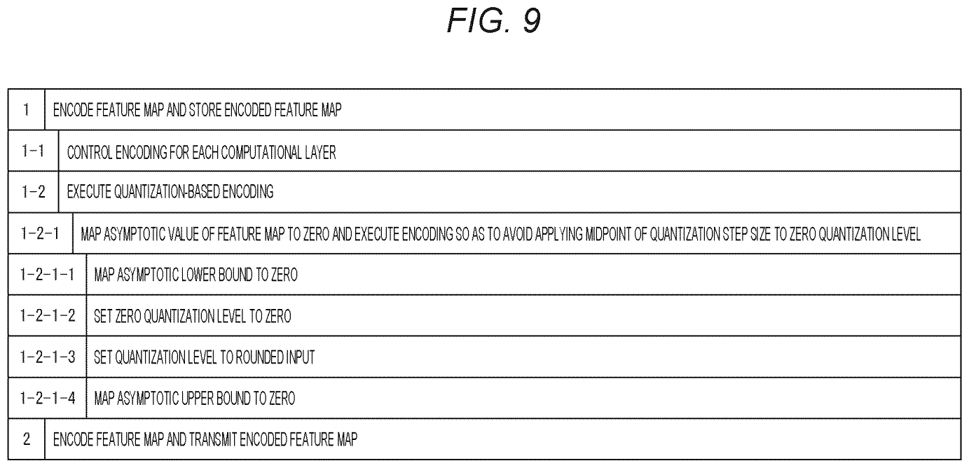

Therefore, as shown in the top of the table in FIG. 9, the feature map obtained as a result of the computational processing is encoded and stored in the memory as encoded data (Method 1). In other words, the encoded data stored in the memory is read and decoded to generate (restore) the feature map, and the feature map is used for the next computational layer.

It is possible to suppress, by executing such encoding, an increase in the data size of the feature map. It is therefore possible to suppress an increase in the memory capacity required for storing the feature map.

### <Method 1-1>

In a case where Method 1 is applied, the encoding of the feature map may be controlled for each computational layer (Method 1-1), as shown in the second row from the top of the table in FIG. 9.

For example, for each layer, whether or not to execute the encoding (and decoding) of the feature map may be controlled. For example, an information processing device including a computational unit that derives a difference between a feature map that is a processing result of a computational layer subject to processing of a neural network and an asymptotic value of an activation function of the computational layer subject to processing, and an encoder that encodes the difference by a quantization-based method where a midpoint of a quantization step size is not set as a quantization level for zero input may further include a control unit that controls whether or not to cause the encoder to encode the difference for each computational layer of the neural network. Furthermore, an information processing device including a decoder that decodes encoded data to generate a difference between a feature map that is a processing result of a computational layer subject to processing of a neural network and an asymptotic value of an activation function of the computational layer subject to processing, and a first computational unit that derives the feature map using the difference and the asymptotic value may further include a control unit that controls whether or not to cause the decoder to decode the encoded data for each computational layer of the neural network.

Furthermore, the encoding (and decoding) parameters may be controlled for each computational layer. For example, the information processing device including the computational unit and the encoder described above may further include a control unit that controls the asymptotic value applied to the computational unit for each computational layer of the neural network. Furthermore, the information processing device including the decoder and the first computational unit described above may further include a control unit that controls the asymptotic value applied to the first computational unit for each computational layer of the neural network.

With such a configuration, the encoding (and decoding) can be executed more efficiently according to the feature map of each layer. It is therefore possible to further suppress an increase in the data size of the feature map.

### <Method 1-2>

Furthermore, in a case where Method 1 or Method 1-1 is applied, any method can be applied to the encoding of the feature map, but it is preferable to use a method with higher encoding efficiency and less latency. For example, a method where a difference value between samples is derived and encoded, like differential pulse code modulation (DPCM), may be applied. Furthermore, as shown in the third row from the top of the table in FIG. 9, a quantization-based encoding method may be applied (Method 1-2). For example, it is possible to reduce, with quantization where, for example, a lower bit is truncated, the data size more reliably and faster, which ensures high throughput and random access. Note that the encoding is lossy.

### <Method 1-2-1>

In a case where Method 1-2 is applied, the encoding is lossy, so that distortion may accumulate in the feature map, potentially affecting the final recognition result. Therefore, as shown in the fourth row from the top of the table in FIG. 9, when the feature map is quantized, data corresponding to the asymptotic value of the activation function may be mapped to zero, and the midpoint of the quantization step size may be prevented from being applied to the zero quantization level (Method 1-2-1).

For example, the information processing device may include a computational unit that derives a difference between a feature map that is a processing result of a computational layer subject to processing of a neural network and an asymptotic value of an activation function of the computational layer subject to processing, and an encoder that encodes the difference by a quantization-based method where a midpoint of a quantization step size is not set as a quantization level for zero input.

Furthermore, the information processing method may include deriving a difference between a feature map that is a processing result of a computational layer subject to processing of a neural network and an asymptotic value of an activation function of the computational layer to subject to processing, and encoding the difference by a quantization-based method where a midpoint of a quantization step size is not set as a quantization level for zero input.

Furthermore, the information processing device may include a decoder that decodes encoded data to generate a difference between a feature map that is a processing result of a computational layer subject to processing of a neural network and an asymptotic value of an activation function of the computational layer subject to processing, and a first computational unit that derives the feature map using the difference and the asymptotic value.

Furthermore, the information processing device including the first computational unit may further include a second computational unit that derives a difference between a feature map of a computational layer subject to processing and an asymptotic value, and an encoder that generates encoded data by encoding the difference by a quantization-based method where a midpoint of a quantization step size is not set as a quantization level for zero input.

Furthermore, the information processing method may include decoding encoded data to generate a difference between a feature map that is a processing result of a computational layer subject to processing of a neural network and an asymptotic value of an activation function of the computational layer subject to processing, and deriving the feature map using the difference and the asymptotic value.

With such a configuration, it is possible to suppress distortion in values near the asymptotic value in the activation function processing of each layer, and it is therefore possible to suppress a reduction in recognition rate.

### <Method 1-2-1>

For example, in a case where Method 1-2-1 is applied, data corresponding to the asymptotic lower bound of the activation function may be mapped to zero (Method 1-2-1-1), as shown in the fifth row from the top of the table in FIG. 9.

For example, the computational unit may derive a difference between the feature map and the asymptotic lower bound of the activation function. Furthermore, the first computational unit may derive the feature map by adding the asymptotic lower bound of the activation function to the difference. Furthermore, the second computational unit may derive the difference between the feature map and the asymptotic lower bound of the activation function.

With such a configuration, it is possible to suppress distortion in values near the asymptotic lower bound of the activation function in the activation function processing of each layer.

### <Method 1-2-1-2>

Furthermore, in a case where Method 1-2-1 or Method 1-2-1-1 is applied, the feature map may be quantized by a method where the zero quantization level is set to zero, as shown in the sixth row from the top of the table in FIG. 9.

For example, the encoder may quantize the difference by a method where the quantization level for zero input is set to zero.

With such a configuration, it is possible to suppress distortion in values near the asymptotic lower bound in the activation function processing of each layer.

### <Additional Configuration>

Note that the information processing device including the computational unit and the encoder described above may further include a feature map generator that executes the computation of the computational layer subject to processing of the neural network to generate the feature map. Furthermore, the information processing device may further include a storage unit that stores the encoded data of the difference generated by the encoder. Moreover, the information processing device may include both the feature map generator and the storage unit.

Furthermore, the information processing device including the decoder and the first computational unit described above may further include a feature map generator that generates the feature map of the next computational layer of the neural network by executing computation of the next computational layer using the feature map derived by the first computational unit. Furthermore, the information processing device may further include a storage unit that stores encoded data, and the decoder may decode the encoded data read from the storage unit.

### <DNN Processing Device>

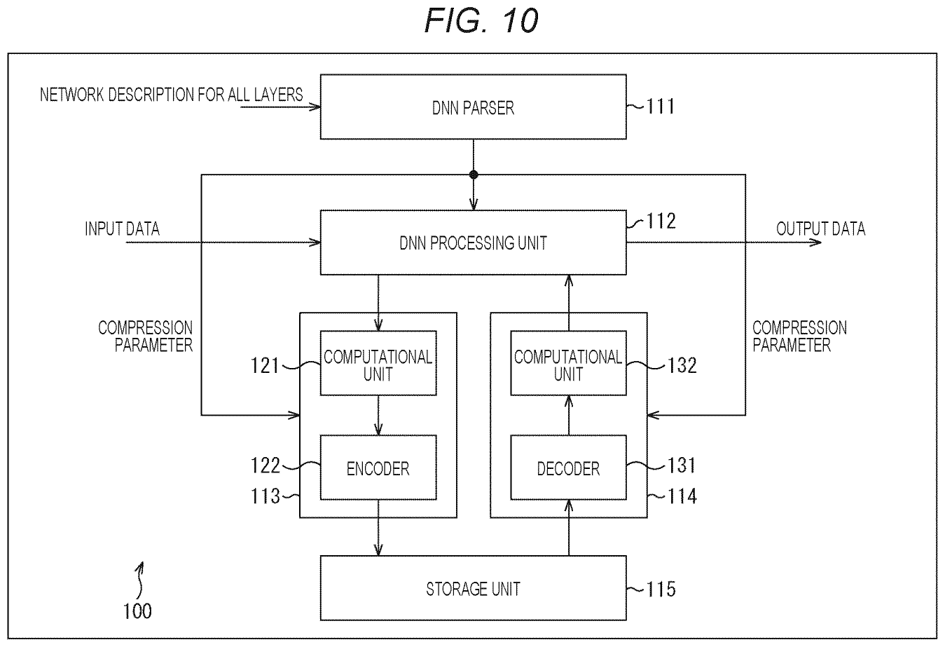

FIG. 10 is a block diagram illustrating a configuration example of a DNN processing device as an aspect of the information processing device to which the present technology is applied. The DNN processing device 100 illustrated in FIG. 10 is a device to which the present technology is applied to execute processing to implement a DNN. That is, in the DNN processing device 100, Method 1 described above may be applied. Alternatively, in the DNN processing device 100, Method 1-1 may be applied. Alternatively, in the DNN processing device 100, Method 1-2 may be applied. Alternatively, in the DNN processing device 100, Method 1-2-1 may be applied. Alternatively, in the DNN processing device 100, Method 1-2-1-1 may be applied. Alternatively, in the DNN processing device 100, Method 1-2-1-2 may be applied.

Note that, FIG. 10 illustrates a primary configuration including devices, data flows, and the like, and those illustrated in FIG. 10 do not necessarily represent all the configuration. That is, the DNN processing device 100 may include a device or a processing unit not illustrated as a block in FIG. 10. Furthermore, there may be a data flow, processing, or the like that is not illustrated as an arrow or the like in FIG. 10.

As illustrated in FIG. 10, the DNN processing device 100 includes a DNN parser 111, a DNN processing unit 112, a feature map encoder 113, a feature map decoder 114, and a storage unit 115. The feature map encoder 113 includes a computational unit 121 and an encoder 122. The feature map decoder 114 includes a decoder 131 and a computational unit 132.

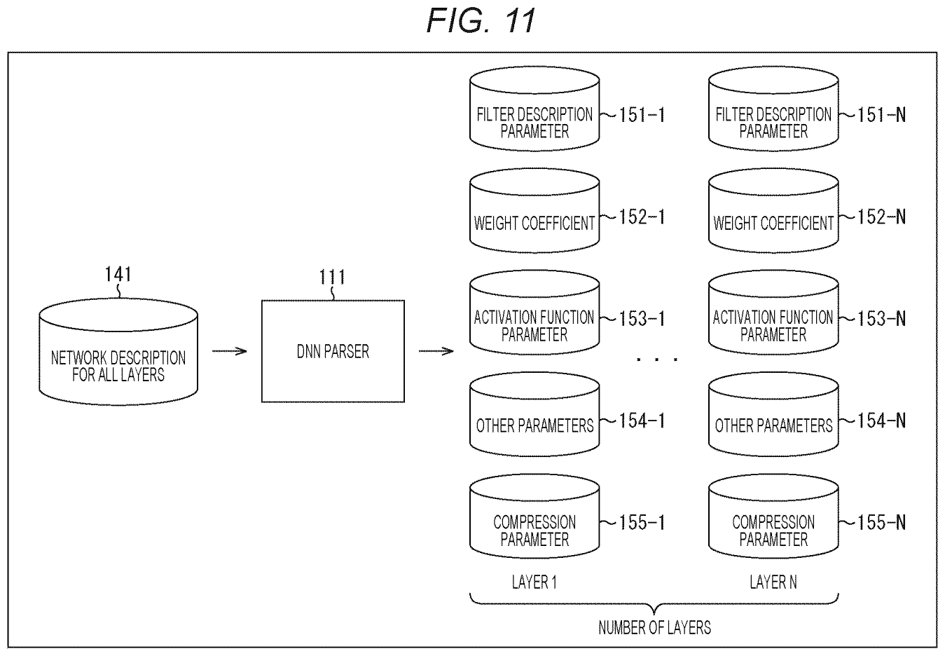

The DNN parser 111 executes processing related to network description parsing. For example, the DNN parser 111 may acquire a network description for all the layers. Furthermore, the DNN parser 111 may parse the network description for all the layers. For example, as illustrated in FIG. 11, the DNN parser 111 parses a network description 141 for all the layers to generate a filter description parameter 151, a weight coefficient (Weight) 152, an activation function parameter 153, other parameters 154, and a compression parameter 155 for each layer of a layer 1 to a layer N. For example, the DNN parser 111 generates, for the layer 1, a filter description parameter 151-1 for the layer 1, a weight coefficient (Weight) 152-1 for the layer 1, an activation function parameter 153-1 for the layer 1, other parameters 154-1 for the layer 1, and a compression parameter 155-1 for the layer 1. Furthermore, the DNN parser 111 generates, for the layer N, a filter description parameter 151-N for the layer N, a weight coefficient (Weight) 152-N for the layer N, an activation function parameter 153-N for the layer N, other parameters 154-N for the layer N, and a compression parameter 155-N for the layer N. It is possible to construct the DNN by applying each piece of data generated as described above to the corresponding layer.

The DNN parser 111 may supply the filter description parameter 151, the weight coefficient (Weight) 152, the activation function parameter 153, and the other parameters 154 generated for each layer to the DNN processing unit 112.

The filter description parameter 151 is information similar to the filter description parameter 31-1 and the like, and may include parameters used in linear filtering processing. For example, the filter description parameter 151 may include information as shown in FIG. 3. Furthermore, the weight coefficient (Weight) 152 may include a weight coefficient used in linear filtering processing. Furthermore, the activation function parameter 153 may include parameters used in activation function processing. For example, the activation function parameter 153 may include information as shown in FIG. 3. Furthermore, the other parameters 154 may include any parameters used in the DNN processing unit 112.

Therefore, the DNN parser 111 can also be said to be a control unit that controls the DNN processing unit 112 (DNN processing executed by the DNN processing unit 112).

Furthermore, the DNN parser 111 may supply the compression parameter 155 generated for each layer to the feature map encoder 113 and the feature map decoder 114.

The compression parameter 155 may include parameters for encoding and decoding. For example, the compression parameter 155 may include a control parameter for controlling whether or not to execute encoding or decoding (for example, flag information indicating whether or not to execute encoding or decoding). Therefore, the DNN parser 111 can also be said to be a control unit that controls whether or not cause (the encoder 122 of) the feature map encoder 113 to execute encoding for each computational layer of the neural network. Furthermore, the DNN parser 111 can also be said to be a control unit that controls whether or not to cause (the decoder 131 of) the feature map decoder 114 to decode encoded data for each computational layer of the neural network.

Furthermore, the compression parameter 155 may include an asymptotic value of an activation function used in the DNN processing unit 112. This asymptotic value can be computed from parameters at the design stage when the network specification is determined. That is, implementation where results obtained by running the DNN parser are held in advance and are used during DNN inference is also possible. The DNN parser 111 can also be said to be a control unit that controls the asymptotic value applied to (the computational unit 121 of) the feature map encoder 113 for each computational layer of the neural network. The DNN parser 111 can also be said to be a control unit that controls the asymptotic value applied to (the computational unit 132 of) the feature map decoder 114 for each computational layer of the neural network.

The DNN processing unit 112 executes processing related to computational processing for implementing the DNN. For example, the DNN processing unit 112 may acquire various parameters (such as the filter description parameter 151, the weight coefficient (Weight) 152, the activation function parameter 153, and the other parameters 154) supplied from the DNN parser 111. Furthermore, the DNN processing unit 112 may execute computational processing for each computational layer using such parameters.

At this time, the DNN processing unit 112 may execute the computational processing on a layer-by-layer basis. In this case, for example, the DNN processing unit 112 may acquire various parameters (such as the filter description parameter 151, the weight coefficient (Weight) 152, the activation function parameter 153, and the other parameters 154) for the computational layer subject to processing. Furthermore, the DNN processing unit 112 may acquire a feature map (input data in a case where the computational layer subject to processing is the first computational layer) obtained as a result of the computational processing of the previous computational layer. For example, in a case where the computational layer subject to processing is not the first computational layer, the DNN processing unit 112 may acquire a feature map supplied from (the computational unit 132 of) the feature map decoder 114. Furthermore, for example, in a case where the computational layer subject to processing is the first computational layer, the DNN processing unit 112 may acquire input data supplied from the outside of the DNN processing device 100.

Then, the DNN processing unit 112 may execute, on the acquired feature map, computational processing of the computational layer subject to processing using various parameters for the computational layer subject to processing. Then, the DNN processing unit 112 may output a feature map generated as a result of the computational processing as a computational result of the computational layer subject to processing.

That is, the DNN processing unit 112 can also be said to be a feature map generator that executes the computation of the computational layer subject to processing of the neural network to generate the feature map. Furthermore, the DNN processing unit 112 can also be said to be a feature map generator that generates the feature map of the next computational layer of the neural network by executing the computation of the next computational layer using the feature map derived by the computational unit 132.

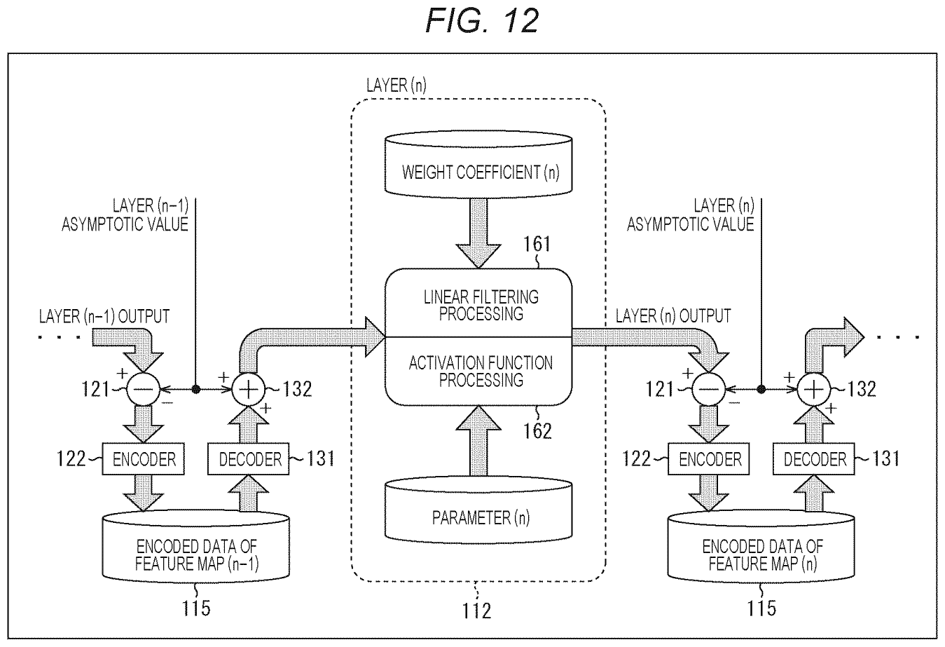

For example, as illustrated in FIG. 12, the DNN processing unit 112 executes linear filtering processing 161 and activation function processing 162 for the computational layer subject to processing (layer (n)). The linear filtering processing 161 is similar to the above-described linear filtering processing 51, and in the linear filtering processing 161, a convolution operation using a convolution filter is executed, for example. For example, the DNN processing unit 112 executes the linear filtering processing 161 of the layer (n) on the feature map (or input data) generated as a result of the computational processing of the previous computational layer (layer (n-1)) using the filter description parameter 151, the weight coefficient (Weight) 152, and the like for the layer (n). The DNN processing unit 112 executes the activation function processing 162 of the layer (n) on the processing result using the activation function parameter 153 and the like for the layer (n) to generate the feature map of the layer (n).

In a case where the computational layer subject to processing (layer (n)) is not the last computational layer, the DNN processing unit 112 supplies the feature map to (the computational unit 121 of) the feature map encoder 113. Furthermore, in a case where the computational layer subject to processing (layer (n)) is the last computational layer, the DNN processing unit 112 outputs the feature map to the outside of the DNN processing device 100 as output data.

The feature map encoder 113 executes processing related to feature map encoding. For example, the feature map encoder 113 may acquire the compression parameter 155 supplied from the DNN parser 111. Furthermore, the feature map encoder 113 may acquire the feature map supplied from the DNN processing unit 112. Furthermore, the feature map encoder 113 may encode the feature map as needed using the compression parameter 155 (i.e., under the control of the DNN parser 111). For example, the feature map encoder 113 may determine whether or not to execute encoding on the basis of the compression parameter 155.

Furthermore, the feature map encoder 113 may supply the encoding result (encoded data in a case where encoding is executed, and a feature map in a case where encoding is skipped) to the storage unit 115 to store the encoding result.

The computational unit 121 executes processing related to computation of a difference value between the feature map and a predetermined value. For example, as illustrated in FIG. 12, the computational unit 121 may acquire the feature map of the computational layer subject to processing (layer (n)) supplied from the DNN processing unit 112. Furthermore, the computational unit 121 may acquire the asymptotic value (layer (n) asymptotic value) of the activation function of the computational layer subject to processing (layer (n)) as the compression parameter 155. Then, the computational unit 121 may derive a difference between the feature map and the asymptotic value. For example, the computational unit 121 may subtract the asymptotic value from the feature map.

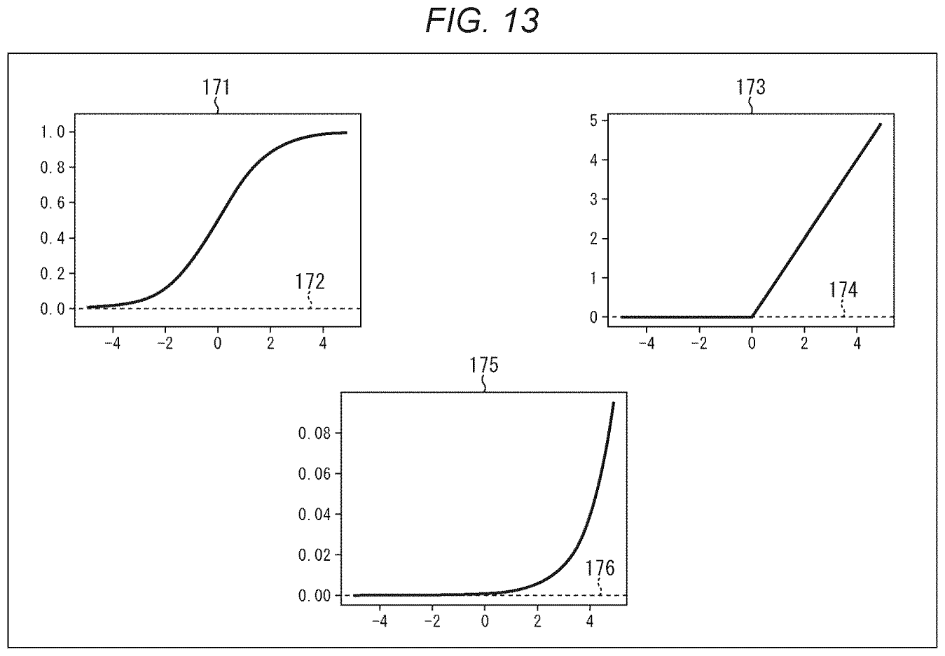

This asymptotic value may be the asymptotic lower bound of the activation function. That is, the computational unit 121 may derive a difference between the feature map and the asymptotic lower bound of the activation function. The activation function may be any function. For example, the activation function may be a sigmoid function as illustrated in a graph 171 in FIG. 13. In this example, a dotted line 172 indicates the asymptotic value (=0). Alternatively, the activation function may be a ReLU function as illustrated in a graph 173 in FIG. 13. In this example, a dotted line 174 indicates the asymptotic value (=0). Alternatively, the activation function may be a softmax function as illustrated in a graph 175 in FIG. 13. In this example, a dotted line 176 indicates the asymptotic value (=0). Note that the asymptotic value is any value and may be other than zero (not limited to the example in FIG. 13). Needless to say, the activation function is also not limited to the example in FIG. 13.

The computational unit 121 may supply the derived difference to the encoder 122.

The encoder 122 executes processing related to encoding of the difference. For example, the encoder 122 may acquire the difference supplied from the computational unit 121. Furthermore, the encoder 122 may encode the difference using the compression parameter 155 supplied from the DNN parser 111.

At this time, the encoder 122 may execute quantization-based encoding. For example, the encoder 122 may encode the difference by a quantization-based method where that the midpoint of the quantization step size is not set as the quantization level for zero input.

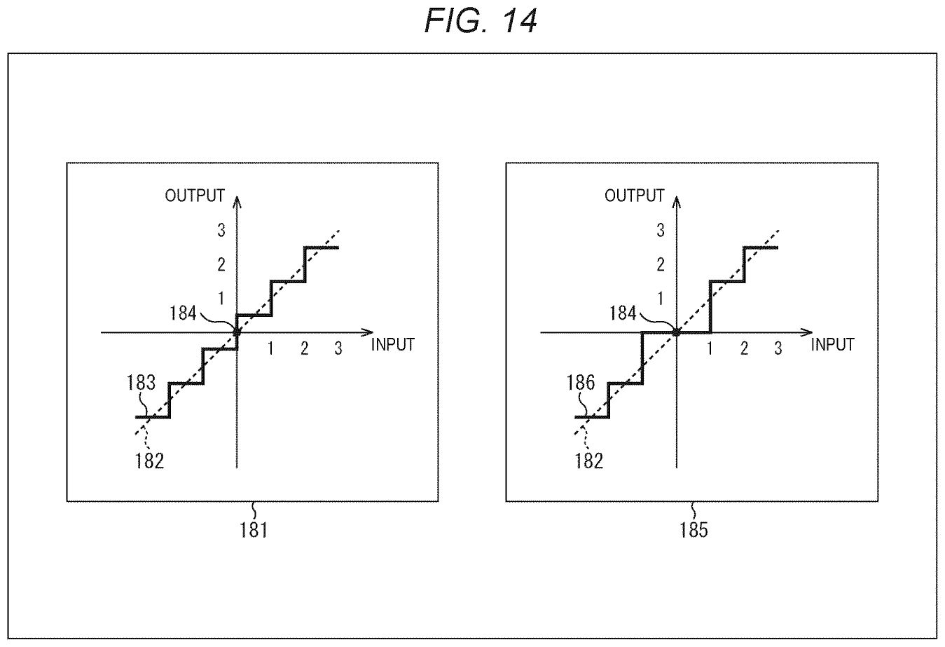

In general, the quantization is executed as in a graph 181 in FIG. 14. That is, quantizing the input indicated by a dotted line 182 generates output as indicated by a bold line 183. That is, as indicated by a point 184, the midpoint of the quantization step size is used for input with a value of “0” in order to reduce a quantization error. Under this method, however, the output (quantization level) for zero input (input with a value of “0”) may vary due to fluctuations in the quantization level or the like.

In order to suppress a reduction in recognition rate due to the accumulation of distortion in the feature map caused by the encoding of the feature map, it is important to suppress distortion near the asymptotic value in the activation function processing of each layer. Therefore, the computational unit 121 maps the asymptotic value to zero, and when encoding the difference, the encoder 122 quantizes the difference so as to avoid setting the midpoint of the quantization step size as the quantization level for zero input. For example, the quantization as illustrated in a graph 185 in FIG. 14 is executed. That is, quantizing input indicated by a dotted line 182 generates output as indicated by a bold line 186. That is, as indicated by a point 184, output with a value of “0” is reliably obtained for the input with a value of “0”. With such a configuration, the asymptotic value can be correctly reproduced during encoding and decoding regardless of the compression ratio. That is, it is possible to suppress a reduction in recognition rate due to the accumulation of distortion in the feature map caused by the encoding of the feature map.

The encoder 122 may supply the encoded data to the storage unit 115 to store the encoded data.

The feature map decoder 114 executes processing related to decoding of the encoded data of the feature map. For example, the feature map decoder 114 may acquire the compression parameter 155 supplied from the DNN parser 111. Furthermore, the feature map decoder 114 may read data (the encoded data of the feature map or the feature map) from the storage unit 115. Further, the feature map decoder 114 may decode the encoded data, and decode the data as needed using the compression parameter 155 (i.e., under the control of the DNN parser 111). That is, in a case where the encoded data of the feature map is read, the feature map decoder 114 may decode the encoded data to generate the feature map. That is, in a case where the feature map is read, the feature map decoder 114 may skip the decoding processing. Furthermore, the feature map decoder 114 may supply the generated (or acquired) feature map to the DNN processing unit 112 as the feature map of the previous computational layer (layer (n-1)).

The decoder 131 executes processing related to decoding of the encoded data of the difference between the feature map and the asymptotic value described above. For example, as illustrated in FIG. 12, the decoder 131 may read the encoded data of the difference from the storage unit 115. Furthermore, the decoder 131 may decode the encoded data using the compression parameter 155 supplied from the DNN parser 111. This decoding method is compatible with the encoding method used by the encoder 122. That is, the decoder 131 decodes the encoded data to generate the difference between the feature map and the asymptotic value. The decoder 131 may supply the difference obtained as a result of decoding the encoded data to the computational unit 132.

The computational unit 132 executes processing related to deriving of the feature map. For example, as illustrated in FIG. 12, the computational unit 132 may acquire the difference supplied from the decoder 131. Furthermore, the computational unit 132 may acquire the asymptotic value (layer (n-1) asymptotic value) of the activation function of the previous computational layer (layer (n-1)) as the compression parameter 155. Then, the computational unit 132 may add the difference and the asymptotic value to derive the feature map of the previous computational layer (layer (n-1)).

This asymptotic value may be the asymptotic lower bound of the activation function. That is, the computational unit 132 may derive the feature map by adding the asymptotic lower bound of the activation function to the difference. The activation function and the asymptotic value are as described above.

The computational unit 132 may supply the derived feature map of the previous computational layer (layer (n-1)) to the DNN processing unit 112.

The storage unit 115 stores the encoded data of the feature map (the encoded data of the difference between the feature map and the asymptotic value). Furthermore, the storage unit 115 may store the feature map. The storage unit 115 stores the encoded data (or the feature map) for each computational layer of the DNN. The storage unit 115 acquires and stores the encoded data (or the feature map) supplied from the feature map encoder 113. Furthermore, the storage unit 115 supplies the stored encoded data (or feature map) to the feature map decoder 114.

<Flow of DNN Processing>

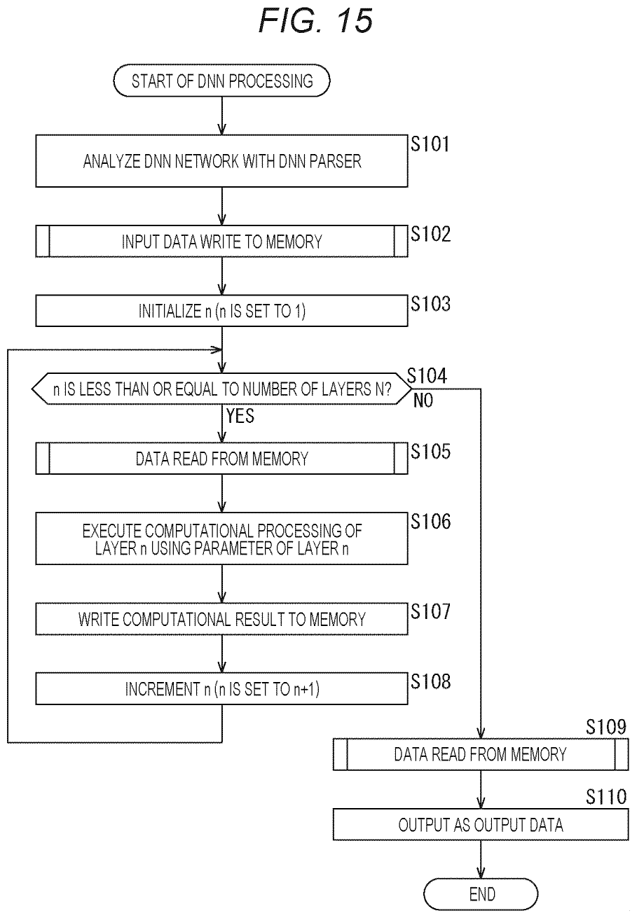

An example of a flow of the DNN processing executed by the DNN processing device 100 will be described with reference to a flowchart in FIG. 15.

Upon the start of the DNN processing, the DNN parser 111 parses the network description for all the layers of the DNN in step S101.

In step S102, the feature map encoder 113 executes data write processing to supply input data to the storage unit 115 to store the input data (write the input data to the memory).

In step S103, the DNN processing unit 112 initializes a parameter n indicating the computational layer subject to processing. For example, the DNN processing unit 112 sets the parameter n to a value of “1”.

In step S104, the DNN processing unit 112 determines whether or not the value of the parameter n is less than or equal to the number of computational layers N of the DNN. In a case where the value of the parameter n is determined to be less than or equal to N (i.e., there is an unprocessed computational layer), the processing proceeds to step S105.

In step S105, the feature map decoder 114 executes data read processing to read data from the storage unit 115. The feature map decoder 114 sets a feature map obtained as a result of the data read processing as the feature map of the previous computational layer (layer (n-1)). Note that, after this processing, in the storage unit 115, the memory area from which the data has been read is released, and the memory area is made writable (data is deleted or the memory area is made overwritable).

In step S106, the DNN processing unit 112 executes computational processing (linear filtering processing and activation function processing) of the layer n on the feature map of the previous computational layer (layer (n-1)) obtained as a result of the processing of step S105, using the parameters of the layer n obtained as a result of the processing of step S101 (parsing the network description).

In step S107, the feature map encoder 113 executes data write processing to encode, as needed, the computational result of the processing of step S106 and supply the encoded data to the storage unit 115 to store the encoded data (write the encoded data to the memory).

In step S108, the DNN processing unit 112 increments the parameter n (adds “1” to the value of the parameter n). When the processing of step S108 is completed, the processing returns to step S104, and the subsequent processing is repeated. That is, the processing of steps S104 to S108 is executed for each computational layer.

Then, in a case where the value of the parameter n is determined to be greater than the number of computational layers N of the DNN in step S104 (i.e., the processing of all the computational layers has been executed), the processing proceeds to step S109.

In step S109, the feature map decoder 114 executes data read processing to read data from the storage unit 115. In step S110, the feature map decoder 114 outputs a feature map obtained as a result of the data read processing as output data. Note that, after this processing, in the storage unit 115, the memory area from which the data has been read is released, and the memory area is made writable (data is deleted or the memory area is made overwritable).

When the processing of step S110 is completed, the DNN processing ends.

As described above, since the feature map is encoded and stored, as needed, in the storage unit 115, the memory capacity required for storing the feature map can be reduced. Furthermore, after data is read from the storage unit 115, the corresponding memory area is released. This allows the feature map encoder 113 to write the computational result to the memory area in step S107. With such a configuration, it is possible to reduce the memory capacity required for storing the feature map.

### <Flow of Data Write Processing>

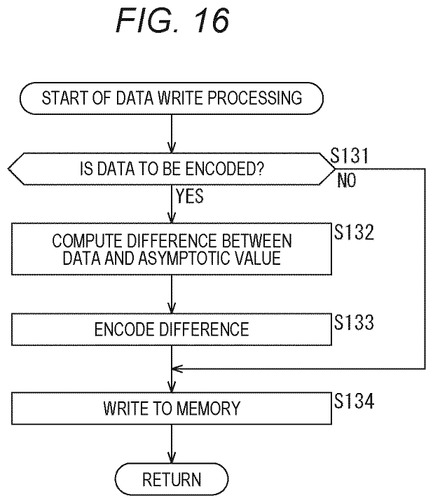

Next, an example of a flow of the data write processing executed in steps S102 and S107 in FIG. 15 will be described with reference to a flowchart in FIG. 16.

Upon the start of the data write processing, the feature map encoder 113 determines whether or not to encode data (feature map or input data) in step S131. For example, in a case where it is determined to encode data on the basis of the compression parameter (control information on the basis of which whether or not to execute encoding is controlled), the processing proceeds to step S132.

In step S132, the computational unit 121 computes a difference between the data and the asymptotic value. For example, the computational unit 121 may derive a difference between the feature map that is the processing result of the computational layer subject to processing of the neural network and the asymptotic value of the activation function of the computational layer subject to processing. For example, the computational unit 121 may derive a difference between the feature map and the asymptotic lower bound of the activation function.

In step S133, the encoder 122 encodes the difference. At this time, the encoder 122 may execute quantization-based encoding. For example, the encoder 122 may encode the difference by a quantization-based method where the midpoint of the quantization step size is not set as the quantization level for zero input. For example, the encoder 122 may quantize the difference by a method where the quantization level for zero input is set to zero.

After the difference is encoded, the processing proceeds to step S134. Furthermore, in a case where it is determined in step S131 that the data is not encoded, the processing proceeds to step S134.

In step S134, the feature map encoder 113 supplies the data to the storage unit 115 to store the data (write the data to the memory). For example, the feature map encoder 113 may supply the encoded data generated by the encoder 122 to the storage unit 115 to store the encoded data. Furthermore, the feature map encoder 113 may supply the feature map of the computational layer subject to processing or the input data to the storage unit 115 to store the feature map or the input data.

When the processing of step S134 is completed, the data write processing ends, and the processing returns to FIG. 15.

### <Flow of Data Read Processing>

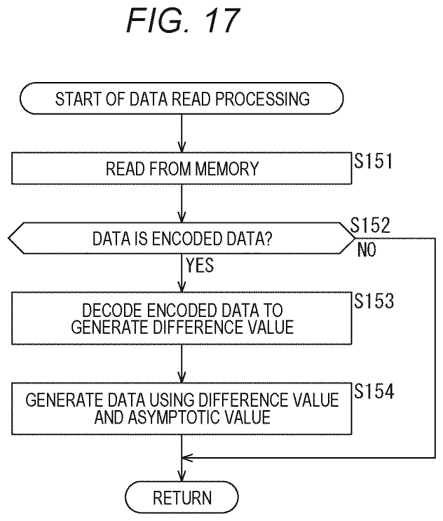

Next, an example of a flow of the data read processing executed in steps S105 and S109 in FIG. 15 will be described with reference to a flowchart in FIG. 17.

Upon the start of the data read processing, the feature map decoder 114 reads data (encoded data or feature map (or input data)) stored in the storage unit 115 in step S151.

In step S152, the feature map decoder 114 determines whether or not the data is encoded data. For example, the feature map decoder 114 determines whether or not to decode the data on the basis of the compression parameter. In a case where it is determined that the read data is encoded data and is to be decoded, the processing proceeds to step S153.

In step S153, the decoder 131 decodes the encoded data to generate (restore) a difference between the data and the asymptotic value. For example, the decoder 131 may decode the encoded data to generate a difference between the feature map that is the processing result of the computational layer subject to processing of the neural network and the asymptotic value of the activation function of the computational layer subject to processing.

In step S154, the computational unit 132 generates data (feature map) using the difference and the asymptotic value. For example, the computational unit 132 may derive the feature map by adding the asymptotic lower bound of the activation function to the difference.

When the processing of step S154 is completed, the data read processing ends, and the processing returns to FIG. 15. Furthermore, in a case where it is determined in step S152 that the read data is the feature map or the input data and is not to be decoded, the data read processing is terminated, and the processing returns to FIG. 15.

Since each processing is executed as described above, the DNN processing device 100 can execute encoding (and decoding) more efficiently according to the feature map of each layer. It is therefore possible to further suppress an increase in the data size of the feature map. Furthermore, applying the quantization-based encoding method allows the DNN processing device 100 to reduce the data size more reliably and faster and ensure high throughput and random access.

Furthermore, when the feature map is quantized, the data corresponding to the asymptotic value of the activation function is mapped to zero, and the midpoint of the quantization step size is prevented from being applied to the zero quantization level, which allows the DNN processing device 100 to suppress distortion of values near the asymptotic value in the activation function processing of each layer and suppress a reduction in recognition rate.

Furthermore, mapping the data corresponding to the asymptotic lower bound of the activation function to zero allows the DNN processing device 100 to suppress distortion of values near the asymptotic lower bound of the activation function in the activation function processing of each layer.

Furthermore, quantizing the feature map by a method where the zero quantization level is set to zero allows the DNN processing device 100 to suppress distortion of values near the asymptotic value in the activation function processing of each layer.

### 3. Application Example

### <Method 1-2-1-3>

Note that, in a case where Method 1-2-1, Method 1-2-1-1, or Method 1-2-1-2 is applied, the feature map may be quantized by a method where a value obtained as a result of rounding the input is used as the quantization level for the input (Method 1-2-1-3), as shown in the seventh row from the top of the table in FIG. 9.

For example, the encoder 122 may quantize the difference by a method where a value obtained as a result of rounding the input is used as the quantization level for the input.

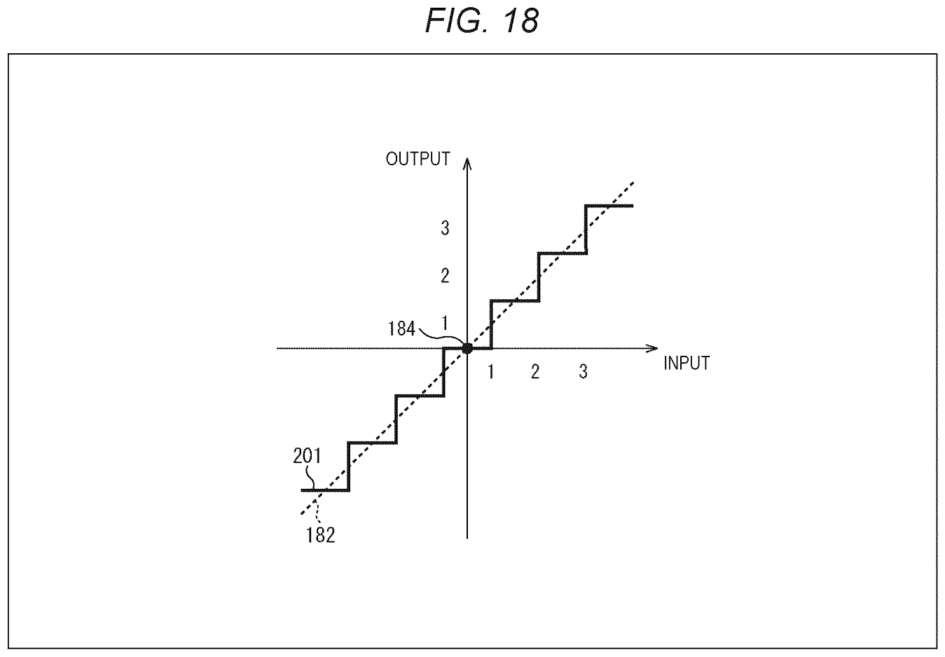

For example, quantization may be executed as illustrated in FIG. 18. That is, quantizing input indicated by a dotted line 182 generates output resulting from rounding the input, as indicated by a bold line 201. With such a configuration, output with a value of “0” is reliably obtained for input with a value of “0” as indicated by a point 184. It is therefore possible to reproduce the asymptotic value correctly during encoding and decoding regardless of the compression ratio. That is, it is also possible to suppress a reduction in recognition rate due to the accumulation of distortion in the feature map caused by the encoding of the feature map.

### <Method 1-2-1-4>

Note that, in the above description, the asymptotic lower bound of the activation function is used, but the asymptotic value is not limited to the asymptotic lower bound, and the asymptotic upper bound of the activation function may be used, for example. That is, in a case where Method 1-2-1, Method 1-2-1-1, Method 1-2-1-2, or Method 1-2-1-3 is applied, the asymptotic upper bound of the activation function may be mapped to zero, as shown in the eighth row from the top of the table in FIG. 9.

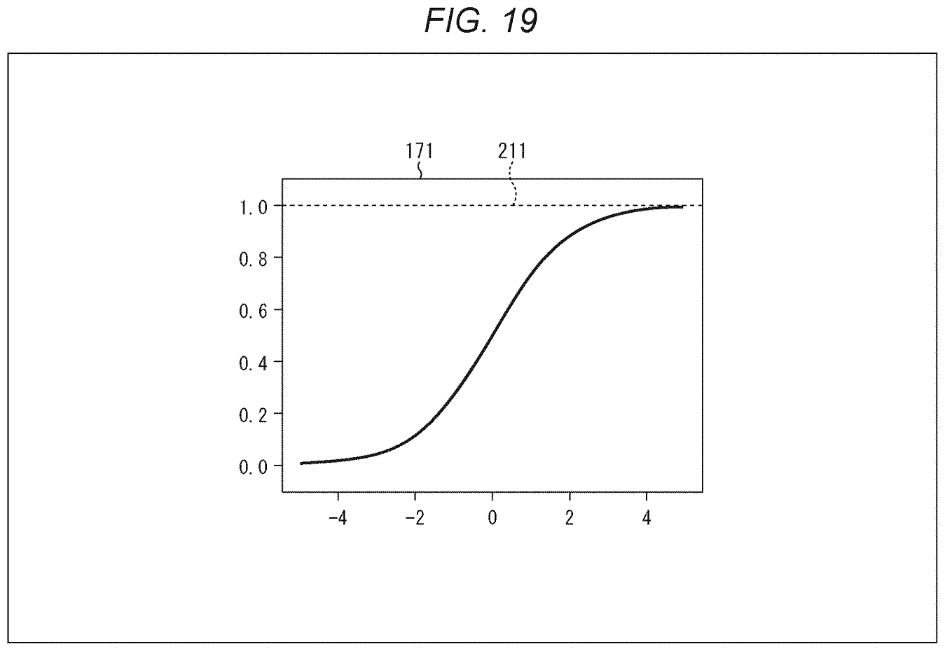

For example, the computational unit 121 may derive a difference between the feature map and the asymptotic upper bound of the activation function. Furthermore, the computational unit 132 may derive the feature map by subtracting the difference from the asymptotic upper bound of the activation function. For example, in a case where a sigmoid function as illustrated in a graph 171 in FIG. 19 is applied as the activation function, the computational unit 121 may derive the difference using an asymptotic upper bound (=1.0) of the sigmoid function indicated by a dotted line 211. Furthermore, the computational unit 132 may derive the feature map using the difference between the feature map and the asymptotic upper bound (=1.0) of the sigmoid function. Needless to say, the activation function and the asymptotic upper bound thereof are determined as desired, and are not limited to this example.

With such a configuration, it is possible to suppress distortion of values near the asymptotic upper bound of the activation function in the activation function processing of each layer.

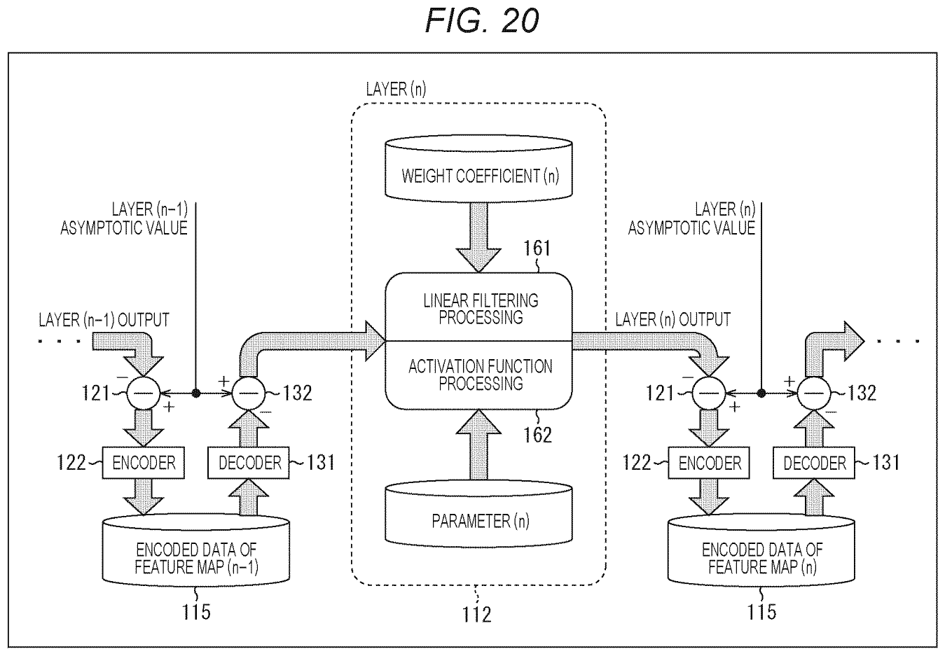

In this case, for example, as illustrated in FIG. 20, the computational unit 121 may derive the difference by subtracting the feature map from the asymptotic upper bound of the activation function. Furthermore, the computational unit 132 may derive the feature map by subtracting the difference from the asymptotic upper bound of the activation function.

Furthermore, both the asymptotic upper bound and the asymptotic lower bound of the activation function may be applied.

### <Method 2>

Although the example where the feature map is stored in the memory has been described above, the present technology can also be applied to other examples. For example, the present technology may be applied to suppress an increase in transmission band (bandwidth or occupancy time, or the like required for an interface or a bus) when the feature map is transmitted.

That is, as shown in the bottom of the table in FIG. 9, the feature map obtained as a result of the computational processing may be encoded and transmitted as encoded data (Method 2). In other words, the feature map may be generated (restored) by decoding the transmitted encoded data.

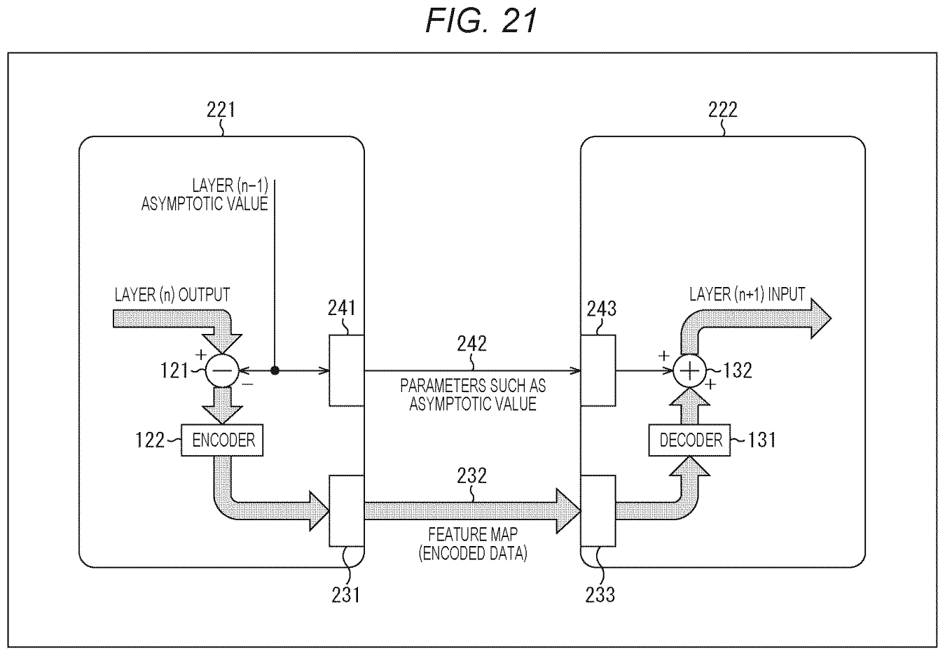

For example, as illustrated in FIG. 21, in a case where the feature map is transmitted between a chip 221 and a chip 222, the present technology may be applied to encode the feature map.

That is, in this case, the encoded data of the feature map generated by the encoder 122 is transmitted to the decoder 131 of the chip 221 via an interface 231, a bus 232, and an interface 233. Furthermore, the asymptotic value supplied from the DNN parser 111 is supplied to the computational unit 132 via an interface 241, a bus 242, and an interface 243 of the chip 221. Therefore, the computational unit 121, the encoder 122, the decoder 131, and the computational unit 132 can execute processing in a manner similar to the case in FIG. 10. That is, the present technology described above in <2. Encoding and decoding of feature map> can be applied. Therefore, also in this case, the effects described above in <2. Encoding and decoding of feature map> can be obtained. That is, it is possible to suppress an increase in transmission band required for transmission of the feature map.

### 4. Appendix

### <Computer>

The above-described series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

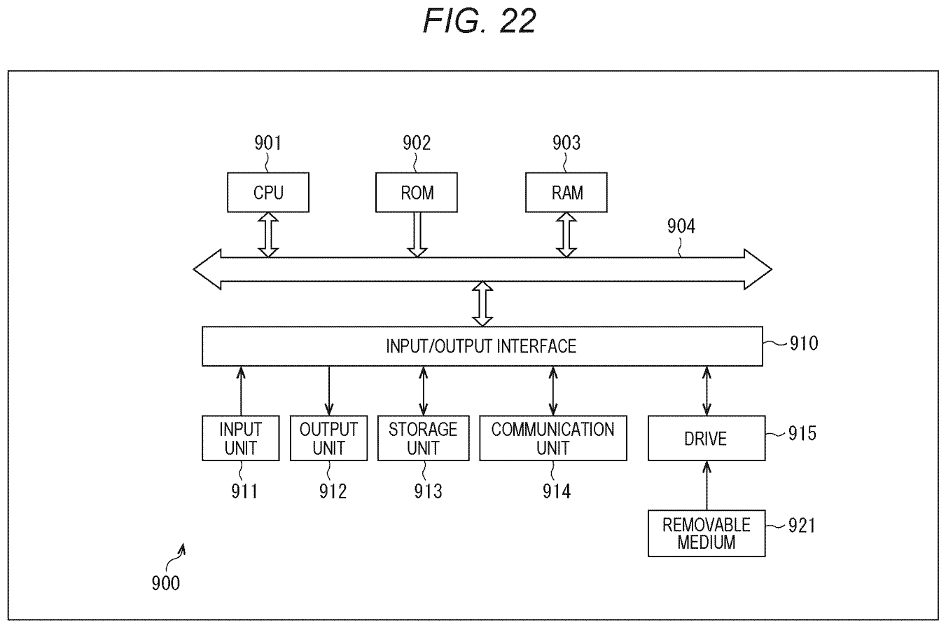

FIG. 22 is a block diagram illustrating a configuration example of hardware of a computer that executes the above-described series of processing in accordance with a program.

In a computer 900 illustrated in FIG. 22, a central processing unit (CPU) 901, a read only memory (ROM) 902, and a random access memory (RAM) 903 are connected to each other via a bus 904.

Furthermore, an input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, or the like. The output unit 912 includes, for example, a display, a speaker, an output terminal, or the like. The storage unit 913 includes, for example, a hard disk, a RAM disk, a non-volatile memory, or the like. The communication unit 914 includes, for example, a network interface. The drive 915 drives a removable medium 921 such as a magnetic disk, an optical disc, a magneto-optical disk, or a semiconductor memory.

In the computer configured as described above, for example, the CPU 901 loads a program stored in the storage unit 913 into the RAM 903 via the input/output interface 910 and the bus 904 and executes the program, whereby the above-described series of processing is executed. Furthermore, the RAM 903 also appropriately stores data and the like necessary for the CPU 901 to execute various types of processing.

A program executed by the computer can be applied by being recorded on the removable medium 921 as a package medium or the like, for example. In this case, the program can be installed in the storage unit 913 via the input/output interface 910 by attaching the removable medium 921 to the drive 915.

Furthermore, the program can also be provided via a wired or wireless transmission medium such as a local area network, the Internet, or digital satellite broadcasting. In this case, the program can be received by the communication unit 914 and installed in the storage unit 913.

In addition, the program can be installed in the ROM 902 or the storage unit 913 in advance.

### <Configuration to Which Present Technology is Applicable>

The present technology can be applied to any configuration. For example, the present technology may be applied to various electronic devices.

Furthermore, for example, the present technology can also be implemented as a partial configuration of a device, such as a processor (for example, a video processor) as a system large scale integration (LSI) or the like, a module (for example, a video module) using a plurality of the processors or the like, a unit (for example, a video unit) using a plurality of the modules or the like, or a set (for example, a video set) obtained by further adding other functions to the unit.

Furthermore, for example, the present technology can also be applied to a network system including a plurality of devices. For example, the present technology may be implemented as cloud computing on which a plurality of devices collaboratively executes processing in a shared manner via a network.

Note that, herein, a system means a set of a plurality of components (devices, modules (parts) and the like), and it does not matter whether or not all the components are in the same housing. Thus, a plurality of devices housed in different housings and connected together via a network and one device in which a plurality of modules is stored in one housing are both systems.

### <Field and Application to Which Present Technology is Applicable>

The system, device, processing unit, and the like to which the present technology is applied can be used in any field such as traffic, medical care, crime prevention, agriculture, livestock industry, mining, beauty care, factory, household appliance, weather, and natural surveillance, for example. Furthermore, any application thereof may be used.

### <Others>

An embodiment of the present technology is not limited to the embodiment described above, and various modifications can be made without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit). Furthermore, it goes without saying that a configuration other than the above-described configurations may be added to the configuration of each device (or each processing unit). Moreover, if the configuration and operation of the entire system are substantially the same, a part of the configuration of a certain device (or processing unit) may be included in the configuration of another device (or another processing unit).

Furthermore, for example, the above-described programs may be executed in any device. In this case, the device is only required to have a necessary function (functional block or the like) and obtain necessary information.

Furthermore, for example, each step of one flowchart may be executed by one device, or may be shared and executed by a plurality of devices. Moreover, in a case where a plurality of pieces of processing is included in one step, the plurality of pieces of processing may be executed by one device, or may be shared and executed by a plurality of devices. In other words, the plurality of pieces of processing included in one step can also be executed as pieces of processing of a plurality of steps. Conversely, processing described as a plurality of steps can also be collectively executed as one step.

Furthermore, for example, in a program executed by the computer, processing of steps describing the program may be executed in a time-series order in the order described herein, or may be executed in parallel or individually at a required timing such as when a call is made. That is, the pieces of processing of the respective steps may be executed in an order different from the above-described order as long as there is no contradiction. Moreover, the processing of the steps describing the program may be executed in parallel with processing of another program, or may be executed in combination with processing of the other program.

Furthermore, for example, a plurality of technologies related to the present technology can be implemented independently as a single entity as long as there is no contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Note that the present technology may also have the following configurations.

(1) An information processing device including:
a computational unit that derives a difference between a feature map that is a processing result of a computational layer subject to processing of a neural network and an asymptotic value of an activation function of the computational layer subject to processing; and
an encoder that encodes the difference by a quantization-based method where a midpoint of a quantization step size is not set as a quantization level for zero input.

(2) The information processing device according to (1), in which
the computational unit derives a difference between the feature map and an asymptotic lower bound of the activation function.

(3) The information processing device according to (2), in which
the encoder quantizes the difference by a method where the quantization level for the zero input is set to zero.

(4) The information processing device according to (2), in which
the encoder quantizes the difference by a method where a value obtained as a result of rounding input is set as a quantization level for the input.

(5) The information processing device according to any one of (1) to (4), in which
the computational unit derives a difference between the feature map and an asymptotic upper bound of the activation function.

(6) The information processing device according to any one of (1) to (5), further including:
a control unit that controls the asymptotic value applied to the computational unit for each computational layer of the neural network.

(7) The information processing device according to any one of (1) to (6), further including:
a control unit that controls whether or not to cause the encoder to encode the difference for each computational layer of the neural network.

(8) The information processing device according to any one of (1) to (7), further including:
a feature map generator that executes computation of the computational layer subject to processing of the neural network to generate the feature map.

(9) The information processing device according to any one of (1) to (8), further including:
a storage unit that stores encoded data of the difference generated by the encoder.

(10) An information processing method including:
deriving a difference between a feature map that is a processing result of a computational layer subject to processing of a neural network and an asymptotic value of an activation function of the computational layer subject to processing; and
encoding the difference by a quantization-based method where a midpoint of a quantization step size is not set as a quantization level for zero input.

(11) An information processing device including:
a decoder that decodes encoded data to generate a difference between a feature map that is a processing result of a computational layer subject to processing of a neural network and an asymptotic value of an activation function of the computational layer subject to processing; and
a first computational unit that derives the feature map using the difference and the asymptotic value.

(12) The information processing device according to (11), in which
the first computational unit derives the feature map by adding an asymptotic lower bound of the activation function to the difference.

(13) The information processing device according to (11) or (12), in which
the first computational unit derives the feature map by subtracting the difference from an asymptotic upper bound of the activation function.

(14) The information processing device according to any one of (11) to (13), further including:
a control unit that controls the asymptotic value applied to the first computational unit for each computational layer of the neural network.

(15) The information processing device according to any one of (11) to (14), further including:
a control unit that controls whether or not to cause the decoder to decode the encoded data for each computational layer of the neural network.

(16) The information processing device according to any one of (11) to (15), further including:
a second computational unit that derives a difference between the feature map of the computational layer subject to processing and the asymptotic value; and
an encoder that generates the encoded data by encoding the difference by a quantization-based method where a midpoint of a quantization step size not set as a quantization level for zero input.

(17) The information processing device according to (16), in which
the second computational unit derives a difference between the feature map and an asymptotic lower bound of the activation function.

(18) The information processing device according to any one of (11) to (17), further including:
a feature map generator that generates the feature map of a next computational layer of the neural network by executing computation of the next computational layer using the feature map derived by the first computational unit.

(19) The information processing device according to any one of (11) to (18), further including:
a storage unit that stores the encoded data, in which
the decoder decodes the encoded data read from the storage unit.

(20) An information processing method including:
decoding encoded data to generate a difference between a feature map that is a processing result of a computational layer subject to processing of a neural network and an asymptotic value of an activation function of the computational layer subject to processing; and
deriving the feature map using the difference and the asymptotic value.

### REFERENCE SIGNS LIST

100 DNN processing device
111 DNN parser
112 DNN processing unit
113 Feature map encoder
114 Feature map decoder
115 Storage unit
121 Computational unit
122 Encoder
131 Decoder
132 Computational unit
221 and 222 Chip
231 Interface
232 Bus
233 Interface
241 Interface
242 Bus
243 Interface
900 Computer

1. An information processing device comprising:
a computational unit that derives a difference between a feature map that is a processing result of a computational layer subject to processing of a neural network and an asymptotic value of an activation function of the computational layer subject to processing; and
an encoder that encodes the difference by a quantization-based method where a midpoint of a quantization step size is not set as a quantization level for zero input.

2. The information processing device according to claim 1, wherein
the computational unit derives a difference between the feature map and an asymptotic lower bound of the activation function.

3. The information processing device according to claim 2, wherein
the encoder quantizes the difference by a method where the quantization level for the zero input is set to zero.

4. The information processing device according to claim 2, wherein
the encoder quantizes the difference by a method where a value obtained as a result of rounding input is set as a quantization level for the input.

5. The information processing device according to claim 1, wherein
the computational unit derives a difference between the feature map and an asymptotic upper bound of the activation function.

6. The information processing device according to claim 1, further comprising:
a control unit that controls the asymptotic value applied to the computational unit for each computational layer of the neural network.

7. The information processing device according to claim 1, further comprising:
a control unit that controls whether or not to cause the encoder to encode the difference for each computational layer of the neural network.

8. The information processing device according to claim 1, further comprising:
a feature map generator that executes computation of the computational layer subject to processing of the neural network to generate the feature map.

9. The information processing device according to claim 1, further comprising:
a storage unit that stores encoded data of the difference generated by the encoder.

10. An information processing method comprising:
deriving a difference between a feature map that is a processing result of a computational layer subject to processing of a neural network and an asymptotic value of an activation function of the computational layer subject to processing; and
encoding the difference by a quantization-based method where a midpoint of a quantization step size is not set as a quantization level for zero input.

11. An information processing device comprising:
a decoder that decodes encoded data to generate a difference between a feature map that is a processing result of a computational layer subject to processing of a neural network and an asymptotic value of an activation function of the computational layer subject to processing; and
a first computational unit that derives the feature map using the difference and the asymptotic value.

12. The information processing device according to claim 11, wherein
the first computational unit derives the feature map by adding an asymptotic lower bound of the activation function to the difference.

13. The information processing device according to claim 11, wherein
the first computational unit derives the feature map by subtracting the difference from an asymptotic upper bound of the activation function.

14. The information processing device according to claim 11, further comprising:
a control unit that controls the asymptotic value applied to the first computational unit for each computational layer of the neural network.

15. The information processing device according to claim 11, further comprising:
a control unit that controls whether or not to cause the decoder to decode the encoded data for each computational layer of the neural network.

16. The information processing device according to claim 11, further comprising:
a second computational unit that derives a difference between the feature map of the computational layer subject to processing and the asymptotic value; and
an encoder that generates the encoded data by encoding the difference by a quantization-based method where a midpoint of a quantization step size not set as a quantization level for zero input.

17. The information processing device according to claim 16, wherein
the second computational unit derives a difference between the feature map and an asymptotic lower bound of the activation function.

18. The information processing device according to claim 11, further comprising:
a feature map generator that generates the feature map of a next computational layer of the neural network by executing computation of the next computational layer using the feature map derived by the first computational unit.

19. The information processing device according to claim 11, further comprising:
a storage unit that stores the encoded data, wherein
the decoder decodes the encoded data read from the storage unit.

20. An information processing method comprising:
decoding encoded data to generate a difference between a feature map that is a processing result of a computational layer subject to processing of a neural network and an asymptotic value of an activation function of the computational layer subject to processing; and
deriving the feature map using the difference and the asymptotic value.
